(19) United States
(12) Patent Application Publication
(10) Pub. No.: US 2008/0033582 A1
(43) Pub. Date: Feb. 7, 2008

(54) Audio capture device for digitally recording analog audio files

(75) Inventors: Leonid Drel, Brooklyn, NY (US); Mark Matthews, Bayonne, NJ (US)

Correspondence Address: HOFFMANN & BARON, LLP, 6900 JERICHO TURNPIKE, SYOSSET, NY, 11791, US

(73) Assignee: GCI Technologies Corp.

(21) Appl. No.: 11/491,217

(22) Filed: Jul. 21, 2006

(51) Int. Cl. G06F 17/00

(52) U.S. Cl. 700/94

(57) ABSTRACT

A device for capturing and recording analog audio signals; comprising an input adapter for connecting to an analog audio source device to receive the audio signals, a processor linked to the input adapter for converting the audio signals to a digital audio file format and an output adapter linked to the processor for directing the digital audio file format to a communications port for exchanging date with an external mass storage device an external control device for generating control signals to the processor based on user inputs and a display device for indicating device status in response to the user inputs.

### FIELD OF THE INVENTION

This invention relates to a device for recording an audio signal from an analog source by converting the audio signal to a digital format file that can be saved on storage media in either a compressed or loss-less format.

### BACKGROUND OF THE INVENTION

It is common for many individuals to have many audio and music files stored on analog media such as record albums, audio magnetic tape. In addition, it is common for individuals to make audio recordings of live events by capturing the live audio and then recording it on some medium. Typically, this is done using an analog recording device which stores the audio recording on an magnetic audio tape or other media.

In a professional setting, there are many sophisticated recording devices available for transferring live or recorded analog audio to an electronic medium. In a home or non-professional setting, there has typically be a limited need for equipment to save live or recorded audio. However, due to the continued expansion of the use of digital audio media, there is now a greater demand for digital media storage solutions that can be easily implemented without expensive equipment or software. In addition, many users have a large collection of analog media, which has limited usefulness and desirability given the current reliance on digital playback devices.

Generally, a home or non-professional user who wish to save live or recorded analog audio to a digital storage medium has a limited number of options available for accomplishing the task. Most typically, the user will need to utilize a personal computer with a dedicated audio capture device and software installed which can then be used to capture and save an audio signal in a digital format. This method however has drawbacks in that it requires specialized equipment and software, and furthermore may require sophisticated knowledge beyond that of a typical user.

Thus, there exists a need for an audio recording device that can capture analog audio signals, convert those signals into a digital format and save the digital file onto digital media. Preferably the device can be conveniently carried by a user to remote locations, requires no sophisticated equipment or knowledge and

### SUMMARY OF THE INVENTION

The audio signal direct recording and playback device of the present invention comprises an input stage including an audio signal format converter having analog inputs, an output stage including a digital outputs. The device can connect directly to the output jack of an external audio signal for purposes of receiving analog audio signals as the signal is played. The device converts the received signals to digital format, compresses the digital signals, and stores the digital audio signals on an external USB storage device through a USB Port. The device includes an external communications port and interface, such as from a Universal Serial Bus, to a personal computer, mass storage device or even an MP3 player. This allows the stored digital audio data to be up-loaded for storage and editing and/or new or updated software to be uploaded to the device.

The present invention therefore provides a device for capturing and recording analog audio signals; comprising an input adapter for connecting to an analog audio source device to receive the audio signals, a processor linked to the input adapter for converting the audio signals to a digital audio file format and an output adapter linked to the processor for directing the digital audio file format to a communications port for exchanging date with an external mass storage device an external control device for generating control signals to the processor based on user inputs and a display device for indicating device status in response to the user inputs.

### BRIEF DESCRIPTION OF THE DRAWINGS

FIG. 1 is a block diagram depicting the device according to the present invention.

### DETAILED DESCRIPTION OF THE PREFERRED EMBODIMENTS:

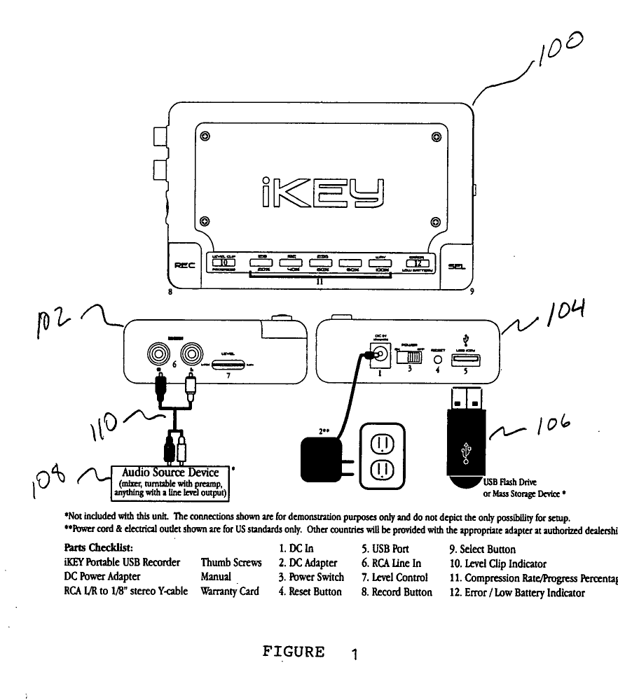

Turning now to FIG. 1, there is shown a block diagram of the playback device according to the present invention. There is shown a top view of the device 100 along with a left side view 102 and a right side view 104. The left side view 104 shows a DC power input 1 for attaching a DC power source 2. The device 100 is turned on via a power switch 3, which turns on the circuits of the device 100. The device can be reset in the event of a system malfunction by a reset button 4 button is used to re-initialize the unit, if there is any error with the connected storage device, or in the event that the unit needs to be restarted for any reason. The device 100 includes a USB port 5 for connecting the device 100 to a USB device such as a USB Flash Drive 106 or other type mass storage device including for example an MP3 player (not shown) The USB PORT 5 is a USB 2.0/1.1/1.0-compatible port used to connect a USB storage device, including, for example USB flash drives, USB external hard disk drives, and most popular MP3 players that connect via USB. When recording, the audio information will be written to this device. The right side of the device includes audio line in connections typically know as RCA jacks for connecting device 100 to an audio source 108 via a RCA audio cable 110. The audio source (not shown) may be a audio capture device such as a microphone or an audio playback device such as a phonograph. The device also includes a level control 7 which 2 is used to control to regulate the audio signal's level when recording. The audio signals level is indicated by the level clip (10) indicator on the top of device 100. The Level Clip 10 indicator will light solidly when there is no input signal detected, or if the signal is too low. The LEVEL CLIP 10 indicator will flash when the input signal is too high. When the signal is within the appropriate range, the level clip 10 indicator will remain unlit.

On the top of device 100 there are controls and indicators for controlling the recording and saving of an audio file as well as providing feedback with respect to the recording. Button 8, REC, abbreviation for record, starts and stops the recording. When a recording is started the present invention creates a new file. Files are numbered according to the order in which they were recorded. When making a recording the user may select between various output file formats via the SEL button 9. By pressing the selector button 9 the user can adjust the output format of the recorded audio signal. The user may compress the file in MP3 format to save space on the storage device, with 3 bit rate options, or selected an uncompressed WAV format. For MP3 format, the user may choose from compression rates of 128 Kbps, 192 Kbps, or 256 Kbps (kilobytes per second). In this way the user can choose an prioritize between both file size and audio playback quality of the recorded digital file.

Also shown on the top of device 100 are a series of LED's which provide feedback to the user regarding the recording process. Specifically, the level clip 10 LED flashes to alert the user when the input signal exceeds the threshold required to make a digital recording free of distortion. The LED lights solidly to alert the user that the input level is too low, or is absent completely.

The line of text above the LEDs indicates the bit rate available to make recordings on the present invention. When using the SEL 9 button to select the bit rate, the respective LED below the bit rate that the user has selected will illuminate. The line of text below the LEDs, made up of percentages, indicates the amount of storage that is occupied on the target storage device. These are referred to as the progress LEDS 11.

When the LED above a particular percentage is flashing, it indicates that the amount of storage occupied is less than the value below the flashing LED. When an LED is solid, it indicates that the storage occupied has exceeded that percentage. When the unit approaches 100% full, the LED display will alert the user by flashing all 5 LEDs repeatedly until the storage device reaches its full capacity. The LED 12 at the far right flashes when the batteries are low or stays solid when there is an error preventing the device from operating.

To use the device according to the present invention the user will supply the device 100 electrical power. Once the unit has been supplied with power using either batteries or the DC adaptor 2 turn the unit on by moving the power switch 3 to the ‘ON’ position. The level clip 10 indicators will light, indicating that there is no input signal. The user then will plug in a USB storage device (e.g., USB flash drive, USB external hard drive, USB compatible MP3 player) into the USB key input 5. Within a few seconds, the unit will detect and initialize the USB storage device. During this time, the user will see USB storage device's activity light illuminate. Once the present invention has initialized the USB storage device, the LED indicators showing the space occupied on the target device will flash a number of time, for example six (6) times.

After the LED(s) indicating the occupied space turn off, the user may use the SEL 9 button to select the desired bit rate for the recording. By pressing the SEL 9 button the user toggles through the bit rates, which include 128 Kbps, 192 Kbps, 256 Kbps, and uncompressed .WAV. At this point, if the user like to check the amount of space occupied on the target device, the user can hold down the SEL 9 button for 3-4 seconds, after which the LEDs will display the space occupied on the target device until the SEL 9 button is released.

After the user has selected the bit rate for the recording, the user may adjust the input level in order to ensure that the recording volume will be adequate, but not so loud that it overloads the inputs of the present invention. Typically this can be done by first adjust the volume of the source to as loud as needed, then adjust the level 7 control so that the input signal does not overload the present invention. To set the recording levels, the user can increase the level 7 control until the level clip 10 indicator begins to flash repeatedly. Then, decrease the level 7 control gradually until the level clip 10 indicator flashes no more than once every 3 to 4 seconds. If the user suspects that the level of the source may increase unexpectedly during recording the user may decrease the level 7 control even more, to insure that clipping does not happen unexpectedly.

Once the user has set all of the necessary parameters, the user may press the REC 8 button to start recording. When the record button is pressed, all of the progress LEDs will flash once to indicate that the unit has understood the command. Once recording has commenced, the present invention will again display the percentage of space occupied on the connected target device. The LED indicating the space that the unit is approaching will flash. If the user wants to instead view the selected bit rate, the user may press the SEL 9 button to toggle between space occupied and bit rate. When the user wants to stop recording, the REC (8) button is pressed again. Immediately after pressing the REC 8 button to stop the recording, the flashing LED indicating the space occupied will turn solid, indicating the end of recording. After the present invention has finished all recording operations and has closed the file, all of the progress LEDs will flash once to indicate that the unit is ready for the next command.

If the user wants to begin recording again, the REC (8) button can be pressed again, which will begin recording a new file. In addition, if, during recording, the storage device approaches full capacity, all progress LEDS 11 will flash repeatedly. As a safeguard, the progress LEDS will begin to flash when there is approximately 5% remaining on the target device. When the target device is full, all LEDs will blink 3 times, indicating that the unit has ceased recording. Then, the 100% fuill indicator will stay solid while the other progress LEDS will flash rapidly to further alert the user. After approximately 3 minutes, all of the progress LEDS will stay solid. To disconnect the target USB storage device the user will press and hold the REC 8 button until all of LED lights flash 3 times consecutively. This gracefully closes the connection with the target device so that it may be disconnected without any risk of corrupting the data that has been recorded to it. Once the disconnect sequence is done, the storage device must be removed and re-connected prior to recording again. If this is not done, all of the LEDs will flash three (3) times indicating that the storage device must be ejected before continuing.

To playback or edit the recording, simply connect the target USB storage device to a computer and view the files on the device. The present will name the files in numerical order according to the order in which they were recorded. Also, note that the filename reflects which file format it is in—MP3 or WAV. The user may then use audio an editing application to manipulate, trim, edit, and save the digital audio file.

It will be appreciated that the present invention has been described herein with reference to certain preferred or exemplary embodiments. The preferred or exemplary embodiments described herein may be modified, changed, added to or deviated from without departing from the intent, spirit and scope of the present invention. It is intended that all such additions, modifications, amendments, and/or deviations be included within the scope of the claims appended hereto.

What is claimed is:

1. A device for capturing and recording analog audio signals; comprising:
an input adapter for connecting to an analog audio source device to receive the audio signals;
a processor linked to the input adapter for converting the audio signals to a digital audio file format and;
an output adapter linked to the processor for directing said digital audio file format to a communications port for exchanging date with an external mass storage device;
an external control device for generating control signals to the processor based on user inputs; and
a display device for indicating device status in response to said user inputs.

2. A device as in claim 1 wherein said input adapter is an RCA adapter.

3. A device as in claim 1 wherein said digital audio file format is an uncompressed audio format.

4. A device as in claim 3 wherein said uncompressed audio format is a WAV format.

5. A device as in claim 1 wherein said digital audio file format is a compressed audio format.

6. A device as in claim 5, wherein said compressed audio format is an MP3 format.

7. A device as in claim 5, wherein said compressed format is compressed at a bit rate of 128 kbps.

8. A device as in claim 5, wherein said compressed format is compressed at a bit rate of 192 kbps.

9. A device as in claim 5, wherein said compressed format is compressed at a bit rate of 256 kbps.

10. A device as in claim 1, wherein said user inputs include selecting said digital audio file format.

11. A device as in claim 1, wherein said communications port is a USB port.

12. A device as in claim 1, wherein said external mass storage device is a USB flash drive.

13. A device as in claim 1, wherein said external mass storage device is a digital audio playback device.

14. A device as in claim 14, wherein said digital audio playback device is an MP3 player.

15. A device as in claim 1, wherein said device status includes the selected bit rate.

16. A device as in claim 1, wherein said device status includes said mass storage device capacity status.

17. A device as in claim 1, wherein said external control device includes a control for adjusting said analog audio signals audio level.

18. A device as in claim 1, wherein said device status includes said audio level
